(19) United States
(12) Patent Application Publication
(10) Pub. No.: US 2005/0198279 A1
(43) Pub. Date: Sep. 8, 2005

(54) Using trend data to address computer faults

(76) Inventors: Philip A. Flocken, Denver, CO (US); Travis Scott Tripp, Fort Collins, CO (US); Yassine Faihe, Grenoble (FR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/984,721

(22) Filed: Nov. 8, 2004

Related U.S. Application Data
(63) Continuation-in-part of application No. 10/442,592, filed on May 21, 2003.
(60) Provisional application No. 60/518,365, filed on Nov. 8, 2003.

(51) Int. Cl. G06F 15/173; G06F 11/00

(52) U.S. Cl. 709/224; 714/4

(57) ABSTRACT

A computer service system uses trend-data software repeatedly to collect status data describing a serviced computer system. The result tend data can be analyzed to provide solutions that can reduce the likelihood of faults and to help pinpoint their causes when they do occur.

### BACKGROUND OF THE INVENTION

This application is a continuation-in-part of copending U.S. patent application Ser. No. 10/442,592, filed May 21, 2003, and further benefits from the filing data for U.S. Provisional Patent Application No. 60/518365. These applications are incorporated in their entireties herein by reference.

The present invention relates to computer systems and, more particularly, to a method for a vendor to service a client computer. The invention provides for economical and effective automated and semi-automated servicing of client computers. Below, related art is discussed to aid in the understanding of the invention. Related art labeled as “prior art” is admitted prior art; related art not labeled “prior art” is not admitted prior art.

Much of modern progress is associated with computers, which are basically “hardware” machines that manipulate data in accordance with “software” programs of instructions. Software programs are generally quite complex: in part because of their intended functionality, and in part due to a requirement to run on a variety of hardware configurations and along with a variety of other software programs. Due to the complexity, software faults are not uncommon. Due to society's increasing dependence on computers, such faults are a significant concern.

Much has been done to minimize the occurrence of faults. Extensive testing, including compatibility testing can be done for many products. When some customers suffer faults, the causes can often be determined and, where appropriate, updates can be offered so that others can avoid the faults. System resources (such as the total and free amounts of memory, the degree of disk fragmentation) can be monitored and warnings can be issued when such resources are strained to the point where faults are likely to occur. Despite these efforts, faults occur far too often.

Computer and software manufacturers have devised various approaches to addressing faults that do occur. Operating systems and programs can provide more or less detailed error messages so that a user is made aware that a fault has occurred. Manuals often include listings of error codes and trouble-shooting guides. Some software provides trouble-shooting wizards to address faults. As a user or customer may not have the expertise to address all faults, many computer and software manufacturers provide telephonic or email support; however, the training and labor costs involved are forcing companies to find ways to limit the number of faults addressed to human support staff. Automated systems, such as fax-back and web-based knowledge bases can be used to provide up-to-date support information.

Most of the foregoing approaches to addressing faults place some burden on the user to aid in diagnosing the problem-e.g., they need to know what operating system there are using. Some error messages avoid this problem by recommending a course of action. Unfortunately, error messages must be preprogrammed and may not embody the most up-to-date knowledge of fault causes and solutions.

Hewlett-Packard Company has developed a “self-healing” system in which software located at a service vendor site responds to faults on customer computers, as described in U.S. patent application Ser. No. 10/442,592. When a fault occurs on a customer computer, client software running on that computer automatically gathers diagnostic data and communicates it to the vendor's system. The vendor's system analyzing the fault data using up-to-date information and provides a solution to the customer in the form of documents from a continually updated knowledge base. The vendor ensures that the solution is the best available, while the diagnostic-data gathering client software ensures accurate diagnostic data without burdening the user/customer. Faults that are not effectively addressed by the automated system can be referred to human support personnel.

### SUMMARY OF THE INVENTION

The present invention provides for collecting trend data for use in providing solutions that either address faults or help avoid them. To this end, trend-data collection software can repeatedly collect computer system status data, including configuration data and performance data. The series of status data collections can be analyzed and compared so such data collections from other computer systems. If similar trends have resulted in faults, a fault can be predicted for the present system with some probability. If the probability of a fault is sufficiently high, a solution can be proposed and/or implemented that is expected to reduce the likelihood of the predicted fault. If a fault does occur, the trend data can be used to help determine a likely cause or causes for the fault, and thus aid in the determination for a solution for addressing the fault. In accordance with a more specific aspect of the invention, the trend data collection can be done in the context of a self-healing environment such as that described above. These and other features and advantages of the invention are apparent from the description below with reference to the following drawings.

### BRIEF DESCRIPTION OF THE DRAWINGS

The figures below pertain to specific embodiments of the invention and are not commensurate with the full scope of the invention.

FIG. 1 is a block diagram of a computer service system in accordance with the present invention.

FIG. 2 is a flow chart of a method of the invention practiced in the context of the system of FIG. 1. Computer Fault Management Using Data Describing Configuration Changes

### DETAILED DESCRIPTION

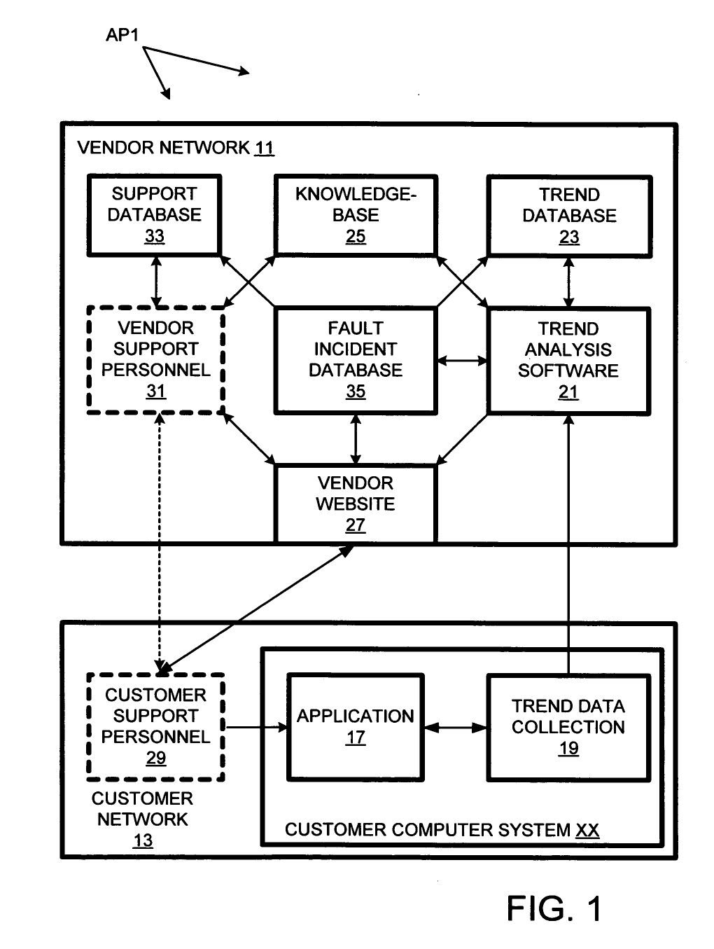

In the automated support system AP1 shown in FIG. 1, a vendor network 11 provides for automated and human support to a customer network 13 in accordance with the present invention. Customer network 13 includes computers, including a computer system 15, each of which runs applications, such as application 17, and trend data collection software 19. Trend data collection software 17 performs the functions of the diagnostic software in U.S. patent application Ser. No. 10/442,592, but further collects status snapshots on an ongoing basis. The “status” can include configuration data, resource utilization data, and performance data. The “ongoing basis” can be periodic, manually triggered, or responsive to configuration changes. In the illustrated embodiment, trend data collection software 19 communicates trend data to vendor network 11 as the data is collected. In an alternative embodiment, the trend data is maintained on customer network 13, e.g., on computer system 15, to be communicated along with fault data to vendor network 11 in response to a fault incident.

Trend and fault data communicated by customer network 13 to vendor network 11 is received by trend analysis software 21. Trend analysis software 31 stores each configuration and each fault in association with previous faults and configuration in a trend database 23. Trends, in the form of a progression of configuration of a computer system such as computer system 15 are compared across computers of customer network 13 and across other networks for which trend data is available, e.g., test machines and computers of other customers.

If the trend associated with customer computer system 15 matches trends of other computer systems that suffered faults, the trend data can be used to predict the probability of a fault for computer system 15. If the risk (a function of the probability and severity of the fault) is sufficiently high, preventative action can be recommended.

A trend prediction requiring preventative action is treated much like a fault incident. The preventative action is a solution, typically described in one or more documents stored in knowledge base 25. Trend analysis software 21 publishes the relevant knowledge-base document to a secure location on vendor's website 27. In addition to or instead of a document, the solution can be in the form of a link to a patch or a discussion forum message or a dynamically generated recommendation for a configuration change. Trend analysis software 21 sends an email notice to customer's customer support personnel 29; the email includes a link that provides access to the solution document on vendor website 27. Alternatively, means other than email can be used for the notification. Customer support personnel 29 can implement the solution or contact vendor's support personnel 31 for further help. In that case, the trend incident converts to a support case and is entered and managed from a separate support database 33. Of course, vendor support personnel 31 have the option of accessing documents in knowledge base 25 and publishing them on vendor website 27 for customer access_{[TT1].}

When a fault occurs on computer system 15, trend data collection software collects data regarding the nature of the fault as well as current configuration data. This is transmitted to vendor network 11, which enters a fault incident into fault-incident database 35. From this point, the trend analysis software 31 can analyze associated trend data in trend database 23 to help determine the cause of the fault.

The invention provides for avoiding some faults that might otherwise result in data loss and costly downtime.

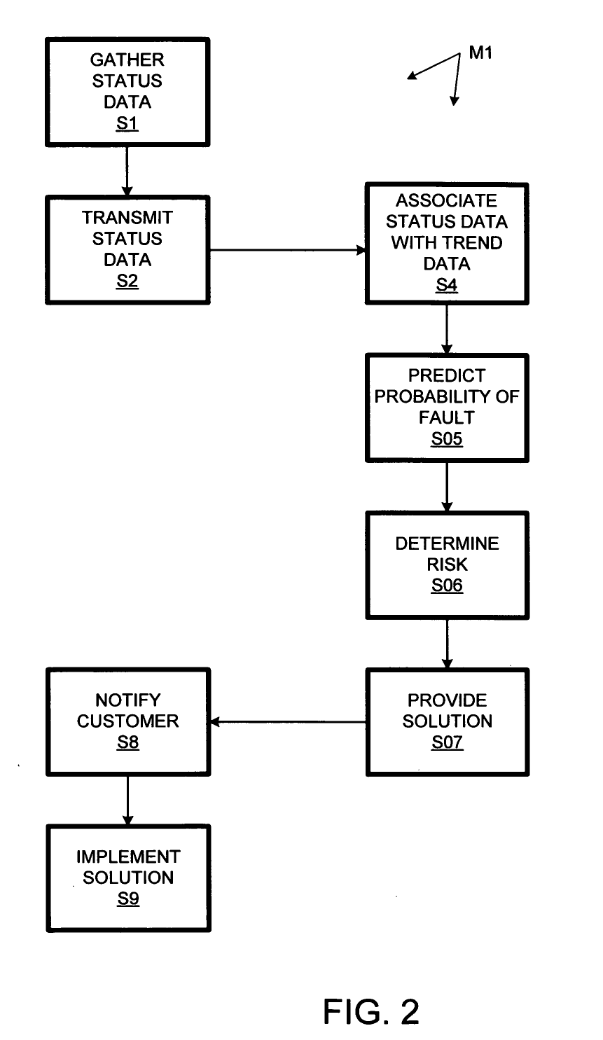

A method M1 of the invention practiced in the context of computer service system AP1 is flow charted in FIG. 2. At step S1, trend data collection software collects computer status data, including configuration and performance data. The status data is collected repeatedly so that the individual collections of status data constitute trend data. At step S2, the collected data is transmitted to vendor network 11, which in turn receives the status data. In the preferred embodiment, each collection of status data is transmitted shortly after collection so that some instances of step S2 precede other instances of step S1. At step S3, trend analysis software 21 on vendor network 11 associates received status data with previously-received status data from the same customer computer system.

At step S4, trend analysis software 21 analyzes the trend data for computer system 15 to predict faults. This analysis can involve comparing the trend for computer system 15 with other trends from other computer systems to find computer systems with similar trends. If the similar trends suffered faults with some frequency, this frequency can be used to determine a probability that a fault will occur on computer system 15 at step S5. If this probability is sufficiently high for a determined severity of the fault type, as determined at step S6, trend analysis software can offer a solution at step S6, which can be made available, e.g., posted on vendor website 27, to customer at step S7. The customer can then be notified, e.g., by email at step S8. Typically, the solution will be in the form of a document that describes a course of action to avoid a fault occurring on computer system 15. Typically, the document gives instructions that a customer can implement at step S9.

In an alternative embodiment, status data is aggregated on a customer system and transferred as aggregate trend data, for example, when a fault incident occurs; in this alternative embodiment, step S3 can be skipped. In this case, steps S3-S6 do not apply, and steps S7 and S8 relate to solutions designed to address rather than avoid a fault. In this alternative embodiment, the trend data is useful in helping to identify the problem that caused the fault. For example, the order in which configuration changes are made can affect whether or not a fault occurs. Thus, when a fault occurs, the trend data can often help pinpoint the optimal solution. On the other hand, this alternative embodiment does not provide one major advantage of the invention, the use of trend data to recommend preventative action to avoid faults. These and other variations upon and modification to the illustrated embodiments are provided for by the present invention, the scope of which is defined by the following claims.

1. A computer fault-management system comprising:
a serviced computer system running data gathering software for detecting faults and for gathering data describing configuration changes over time prior to a detected fault;
a service computer system for analyzing said data to provide a solution for addressing a detected fault; and
communication software for communicating said data from said serviced computer system to said service computer system.

2. A computer fault-management system as recited in claim 1 wherein said communication software communicates said data as it is gathered so that some of said data is communicated before other of said data is gathered.

3. A computer fault-management system as recited in claim 2 wherein said service computer system analyzes said data to predict the occurrence of a potential fault and to provide a solution for avoiding actualization of said potential fault.

4. A computer fault-management system as recited in claim 3 wherein said service computer system applies a trending analysis to said data to predict the occurrence of a potential fault and to provide a solution for avoiding actualization of said fault.

5. A computer fault-management system wherein said serviced computer system is a customer computer system and said service computer system is a vendor computer system, said communication software providing for communication between said service computer system and said serviced computer system over the Internet.
